(19) United States
(12) Patent Application Publication
(10) Pub. No.: US 2008/0151106 A1
(43) Pub. Date: Jun. 26, 2008

(54) Reducing Artefacts In Scan-Rate Conversion Of Image Signals By Combining Interpolation And Extrapolation Of Images

(75) Inventors: Reinout Jacques Noel Verburgh, Brugge (BE); Harold Benten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,022

(22) PCT Filed: Feb. 18, 2005
(86) PCT No.: PCT/IB2005/050610

§ 371 Date: Aug. 16, 2006

(30) Foreign Application Priority Data
Feb. 23, 2004 (EP) 04100698.2

(51) Int. Cl. H04N 7/01

(52) U.S. Cl. 348/452; 348/E07.003

(57) ABSTRACT

This invention relates to a method, a device, a computer program and a computer program product for scan-rate conversion of an image signal, comprising interpolating between at least a first image area of a first image of said image signal and a second image area of a second image of said image signal to obtain at least one interpolated image area, extrapolating at least one image area of at least one image of said image signal to obtain at least one extrapolated image area, and mixing said at least one interpolated image area and said at least one extrapolated image area to obtain a mixed image area. Said step of mixing advantageously depends on the decision whether the image area that is to be interpolated and/or extrapolated is an occlusion area, and on the accuracy of at least one determined motion vector.

This invention relates to a method, a device, a computer program and a computer program product for scan-rate conversion of image signals.

Scan-rate conversion of image signals is required in a wide field of video applications. For instance, scan rate conversion is necessary to adopt the image frequency of an image signal obeying a first video standard to an image frequency as demanded by a second video standard. This process usually incorporates interpolation of images. However, interpolation of images may cause annoying artefacts in the interpolated images.

The halo artefact is one of the most annoying artefacts remaining in motion-compensated scan-rate conversion systems as deployed in modern high-end TV sets. In these motion-compensated scan-rate conversion systems, a new image is interpolated in-between two original images by shifting selected pixels from both images over the estimated motion vectors, which describe the displacement of pixels or blocks of pixels between two successive images of an image signal, and by performing some linear (e.g. averaging) or non-linear (e.g. median filtering) operations, or both of them, on the shifted pixels. The halo artefact mainly occurs when interpolation is performed in so-called occlusion areas, i.e. image areas in two images that shall be used for interpolation and that differ to a degree that renders the matching of image areas or blocks in said two images during the motion vector estimation procedure impossible.

State-of-the-art scan-rate conversion systems apply different processing in occlusion areas to mitigate halo artefacts, for instance by replacing bi-directional interpolation by uni-directional image processing (e.g. simple pixel fetching from one of the two images that are to be interpolated) when occlusion areas are detected. For instance, international application WO 00/11863 proposes to detect the presence of edges in images of an image signal as an indicator for occlusion areas and to perform bi-directional or uni-directional processing depending on the detected occlusion areas.

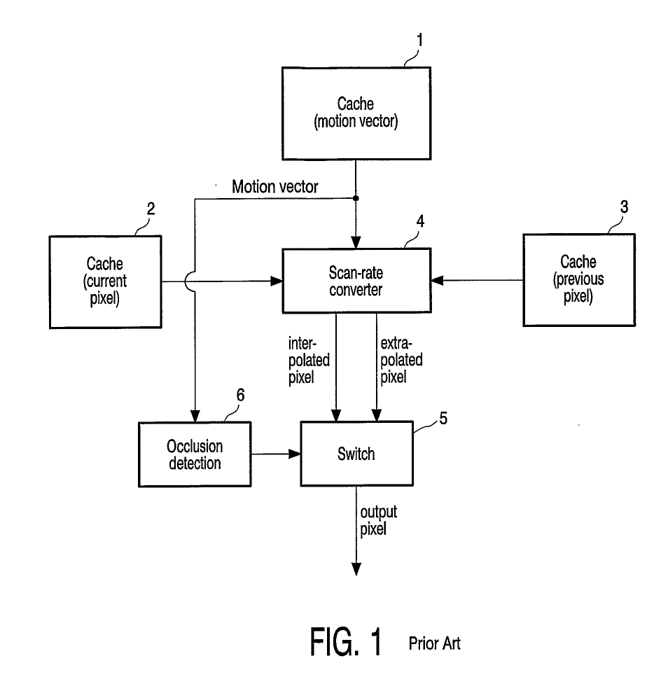

FIG. 1 schematically depicts a state-of-the-art scan-rate conversion system as is for instance deployed in WO 00/11863. The system comprises a cache 1 for the storage of the determined motion vectors, a cache 2 for the storage of the pixels of the current image and a cache 3 for the storage of the pixels of the previous image. The caches are continuously updated with new motion vectors and pixels in synchronism with the operation of the scan-rate converter 4. Motion vectors may for instance be coarsely determined by a block-matching algorithm that defines a block (e.g. a macro-block composed of 16×16 pixels) in the previous image and searches for a similar block in the current image, wherein the two-dimensional displacement vector then represents the motion vector. Of course, more concise estimation techniques for objects within the blocks or involving several images of a video signal may be applied as well. The determined motion vector and those pixels from the previous and current image that are associated with the block formed in the block-matching process are then continuously fed into the scan-rate converter 4, which interpolates the current and previous pixels to obtain interpolated pixels and extrapolates pixels from either the previous or current image to obtain extrapolated pixels. The interpolation process may for instance be accomplished by shifting the pixels from the previous and current image over the determined motion vectors and performing some linear (e.g. averaging) and/or non-linear (e.g. cascaded median filtering) operations on them. In any case, interpolation can be considered as bi-directional image processing technique because the resulting interpolated pixels contain information from both the previous and current image. The extrapolation process, in contrast, relies on information from one of said previous and current images only. For instance, only motion compensation may be performed on the pixels of the previous image by shifting them over the determined motion vectors. Extrapolation thus represents a uni-directional image processing technique.

The interpolated and extrapolated pixels are then fed into a switch 5, that selects either the interpolated or the extrapolated pixels as final output pixels of the scan-rate conversion system. The decision on which of the interpolated or extrapolated pixels to select is based on the detection of occlusion areas in the images of the video signal, which is performed by an occlusion detection instance 6 based on the determined motion vector. If it is determined by said occlusion detection instance 6 that the image area the actually processed pixels belong to is an occlusion area, the extrapolated pixels instead of the interpolated pixels are selected by the switch 5 in order to reduce the amount of halo artefacts in the scan-rate converted image. If it is decided that the image are the actually processed pixels belong to is not an occlusion area, the switch selects the interpolated pixels as final output signal of the scan-rate conversion system, because the occurrence of halo artefacts is unlikely when non-occlusion areas are interpolated.

Uni-directional image processing such as the extrapolation technique applied in the state-of-the-art scan-rate conversion system of FIG. 1 extremely depends on the quality of the determined motion vector field. Even if a correct motion vector is determined for the image area that is extrapolated, for instance a background motion vector of an image, new types of annoying artefacts arise in the scan-rate converted image signal, in particular in the case of complex motion in the image signal. Experiments show that even the application of a spatial blur filter to the occlusion areas does not remove these new types of artefacts.

In view of the above-mentioned problems, it is, inter alia, an object of the present invention to provide a method, a device, a computer program and a computer program product for improved scan-rate conversion of an image signal.

It is proposed that a method for scan-rate conversion of an image signal comprises interpolating between at least a first image area of a first image of said image signal and a second image area of a second image of said image signal to obtain at least one interpolated image area, extrapolating at least one image area of at least one image of said image signal to obtain at least one extrapolated image area, and mixing said at least one interpolated image area and said at least one extrapolated image area to obtain a mixed image area.

Said scan-rate conversion method may for instance be a motion-compensated scan-rate conversion method on pixel or sub-pixel basis and may be applied in various types of multimedia devices such as television sets, set-top boxes, digital and analogue receivers, broadcasting stations, computers or hand-held devices in order to change the image frequency of said image signal. In particular, up-conversion of video signals for High Definition Television (HDTV) systems may be accomplished with said scan-rate conversion method. Accordingly, said image signal may obey a variety of image or video standards, it may for instance represent a television signal according to the National Television System Committee (NTSC), Phase Alternating Line (PAL) or Sequential Couleur Avec Memoire (SECAM) standard.

Said image signal is generally composed of a sequence of images, which in turn consists of rows and columns of Picture Elements (pixels). Groups of said pixels form an image area within each image, for instance a block of pixels. Interpolation may be performed in order to determine an image area of a desired scan-rate converted image signal, wherein said image temporally lies between two given images of an input image signal that is to be converted. In general, only one respective image area within each of said first and second images is considered for the interpolation, yielding an interpolated image area. Alternatively, the complete first and second images may be considered for the interpolation. It may also be advantageous to incorporate the pixel information of more than two images in the interpolation process.

The interpolation process may for instance be accomplished by shifting the pixels from the respective first and second image area of said first and second image over corresponding motion vectors and performing some linear (e.g. averaging) and/or non-linear (e.g. median filtering or cascaded median filtering) operations on them, wherein said motion vectors may for instance be determined by a block-matching algorithm that defines an image area in the first image and searches for a similar image area in the second image, wherein the two-dimensional displacement vector then represents the motion vector. Equally well, more concise estimation techniques involving several images of an image signal may be applied as well. As seen from the view of the interpolated image area, said interpolation thus may be imagined as bi-directional image processing technique.

In contrast, said extrapolation of said at least one image area of said at least one image of said image signal sets out from an image area in one image only and determines said extrapolated image area without merging pixel information from two images of said image signal. For instance, in a method without motion-compensation, the extrapolated pixel may simply be an unprocessed pixel of said at least one image of said image signal. In a method with motion compensation, said extrapolated pixel may be obtained by shifting a pixel of said at least one image over a corresponding motion vector. As seen from the view of the extrapolated image area, the extrapolation thus may be imagined as uni-directional image processing technique. Said at least one image signal may be identical with either said first or second image, or represent a further image. Equally well, said at least one image area may be identical with said first or second image area, or represent a further image area.

Said step of mixing said at least one interpolated image area and said at least one extrapolated image area may for instance be represented by a weighted addition of said at least one interpolated image area and said at least one extrapolated image area. Thus the luminance and/or chrominance values of the pixels of said interpolated image area may be multiplied with a first factor and accordingly the luminance and/or chrominance values of the pixels of said extrapolated image area may be multiplied with a second factor before the addition.

This weighted addition allows to seemlessly fade between the interpolated image area as mixed image area and the extrapolated image area as mixed image area and vastly contributes to reducing artefacts in the mixed image area that is finally output by the scan-rate converter. If for instance extrapolation was performed for image areas that are identified as occlusion areas, and if the determined motion vectors on which the extrapolation is based on are inaccurate, in state-of-the-art scan-rate conversion systems the occurrence of new types of artefacts is inevitable due to the simple switching operation between the interpolated image area and the extrapolated image area as mixed image area. However, according to the method of the present invention, it is not only possible to switch between the interpolated image area and the extrapolated image area when selecting the finally output mixed image area, but to output an image area that comprises contributions of both the interpolated and extrapolated image areas. In the present example, it is thus possible to reduce the contribution of the extrapolated image area in the mixed image area in favor of the interpolated image area. This leads to an overall mitigation of conversion artefacts and to an improved perception quality of the converted image signal.

The choice on the weight factors during the mixing step can for instance be based on a criterion that rates the accuracy of the determined motion vectors or on pre-defined or dynamically adjusted threshold values.

According to the method of the present invention, it may be advantageous that the method further comprises identifying occlusion areas in said images of said image signal. Said occlusion areas may for instance be identified by means of motion vector estimation and edge detection. The remaining areas of an image then may be identified as non-occlusion areas.

According to the method of the present invention, it may be advantageous that said step of mixing is at least partially performed in dependence on a decision whether said image areas that are interpolated and/or extrapolated are occlusion areas. Halo effects only occur when interpolation is performed for image areas that are occlusion areas. It is thus advantageous to incorporate knowledge on the characteristics of image areas that are interpolated and/or extrapolated into the mixing step. When the image area is a non-occlusion area, the mixing can be performed in a manner that the mixed image area is entirely composed of the interpolated image area without any influence of the extrapolated image area. In contrast, if the image area is an occlusion area, it might be advantageous to decrease the contribution of the interpolated image area in the mixed image area in favor of the extrapolated image area, because interpolation in occlusion areas causes halo artefacts.

According to the method of the present invention, it may be advantageous that the method further comprises determining at least one motion vector and at least one associated matching error for at least one image area of at least one image of said image signal. Said motion vectors describe the movements of objects from image to image, for instance by a block-matching algorithm that may set out from an image area or block within a first image and then search a similar image area or block in a second image, wherein the two-dimensional displacement between said image areas or blocks within said two images then may represent a motion vector. For each determined motion vector, which corresponds to an image area or block the displacement of which it describes, a matching error can be computed, which quantifies the difference between said image area or block of said first image when it has been projected by said motion vector and the image area or block in the second image.

According to the method of the present invention, it may be advantageous that said step of mixing is at least partially performed in dependence on said at least one determined matching error. It is thus possible that said step of mixing depends on the decision whether the image area that is interpolated and/or extrapolated is an occlusion area or not and on said determined matching error. Said matching error may for instance serve as an indicator for the accuracy of the determined motion vectors, and the weighting factors with which said interpolated image area and said extrapolated image area may be multiplied before their addition in said step of mixing may depend on said matching error. The contribution of said interpolated and extrapolated image areas in the mixed image area that is finally output by said scan-rate conversion method after the mixing step thus can be adapted to the quality of the motion vectors. If the motion vectors are erroneous, the contribution of the interpolated image area is increased, and if the motion vectors are accurate, the contribution of the extrapolated image area is increased. This is of particular importance if it has been decided that the image area that is to be interpolated and/or extrapolated is an occlusion area. Then, the contributions of the interpolated image area and the extrapolated image area in the mixed image area may be adjusted according to said matching errors, whereas if it is decided that a non-occlusion area is presently processed, the mixed image area may be directly set to the interpolated image area without any need for considering the matching error in the mixing step.

In a motion-compensated scan-rate conversion system, the calculation of matching errors is an integral part of the motion vector estimator, so that there arises no additional computational complexity when driving the mixing operation based on said matching errors.

According to the method of the present invention, it may be advantageous that said at least one matching error is determined according to a Sum of Absolute Differences (SAD) criterion. Then the absolute differences of the luminance and/or chrominance values between all pixels within an image area or block of a first image that has been projected by a corresponding motion vector and the pixels in the corresponding image area or block in a second image is summed up. Alternatively, the Mean Square Error (MSE) criterion may be applied for the matching error.

According to the method of the present invention, it may be advantageous that said at least one matching error is determined on the basis of pixels, lines, blocks or fields and in a predefined pattern for said at least one image area. Calculating the matching error on the basis of lines, blocks or fields may help to reduce the computational complexity as compared to the case where all pixels of an image area or block have to be considered.

According to the method of the present invention, it may be advantageous that said at least one matching error, in dependence on which said step of mixing is performed, corresponds to an image area that is a non-occlusion area. Matching errors that are derived from occlusion areas may be inaccurate, so that it then may be advantageous to use matching errors from other, possibly neighboring image areas that are non-occlusion areas.

According to the method of the present invention, it may be advantageous that said non-occlusion image area is selected in dependence on the difference between its corresponding motion vector and a desired motion vector. Said desired motion vector may for instance be a background motion vector, which may be determined by using a pan-zoom model. Then an image area is selected, which is not an occlusion area and the motion vector of which is close to said background motion vector. The matching error corresponding to said image area then is used for the mixing step.

According to the method of the present invention, it may be advantageous that said non-occlusion area is located in the vicinity of at least one occlusion area that is interpolated and/or extrapolated. It may for instance be advantageous to test image areas at the left and the right of an image area that is interpolated and/or extrapolated if said image area is identified as occlusion area. If these image areas at the left and the right are non-occlusion areas, their corresponding motion vectors may be determined and compared with a desired motion vector, for instance a background motion vector. Then the matching error corresponding to the motion vector that is closest to the background motion vector is used for the mixing of the interpolated and extrapolated image areas.

It is further proposed a computer program with instructions operable to cause a processor to perform the above-described method steps. Said processor may for instance be the central processor of a multimedia device that renders and/or converts said image signal.

It is further proposed a computer program product comprising a computer program with instructions operable to cause a processor to perform the above-described method steps.

It is further proposed a device for scan-rate conversion of an image signal, the device comprising means for interpolating between at least a first image area of a first image of said image signal and a second image area of a second image of said image signal to obtain at least one interpolated image area, means for extrapolating at least one image area of at least one image of said image signal to obtain at least one extrapolated image area, and means for mixing said at least one interpolated image area and said at least one extrapolated image area to obtain a mixed image area.

According to the device of the present invention, it may be advantageous that the device further comprises means for identifying occlusion areas in said images of said image signal.

According to the device of the present invention, it may be advantageous that the device further comprises means for determining at least one motion vector and at least one associated matching error for at least one image area of at least one image of said image signal.

These and other aspects of the invention will be apparent from and elucidated with reference to the embodiments described hereinafter.

In the figures show:

FIG. 1. a scan-rate conversion system according to the prior art;

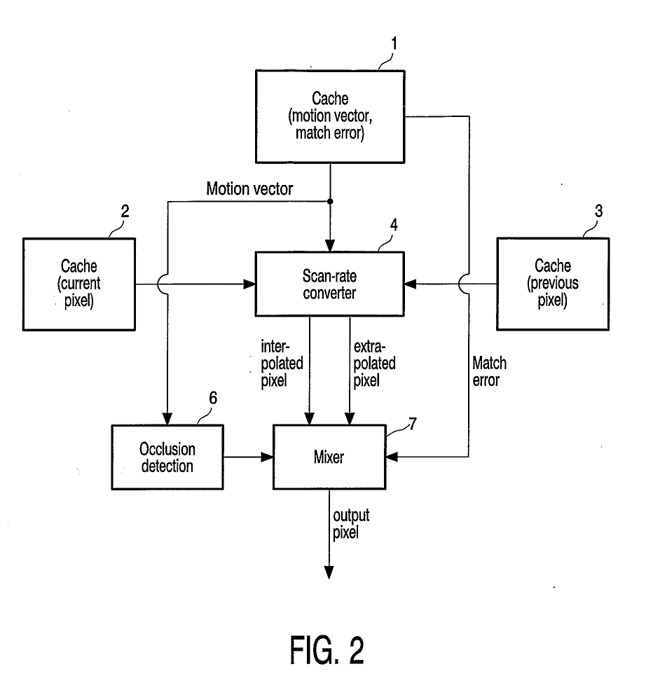

FIG. 2. a scan-rate conversion system according to the present invention; and

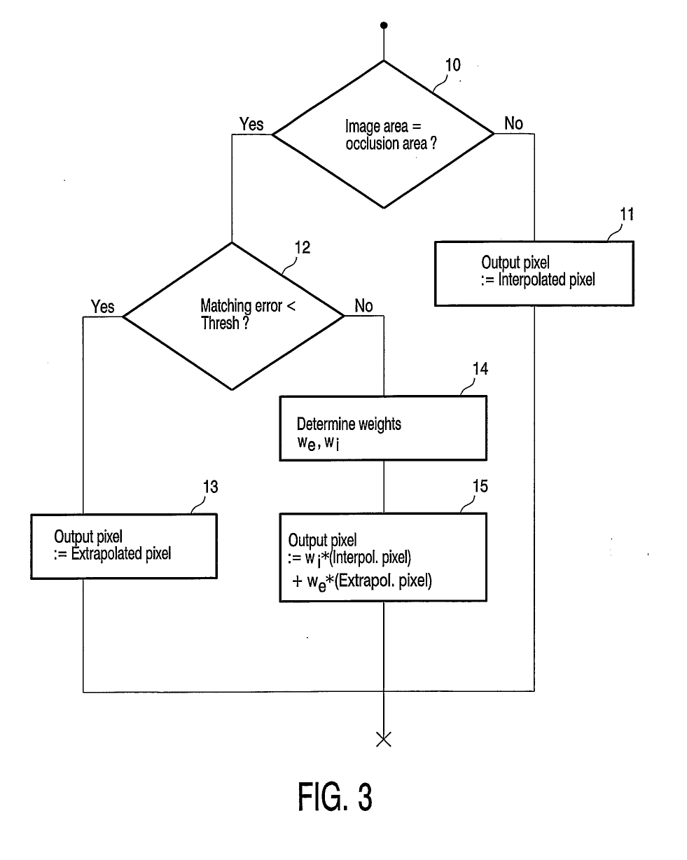

FIG. 3. a flowchart of the method according to the present invention.

FIG. 2 schematically depicts a scan-rate conversion system according to the present invention. The basic set-up of the system of FIG. 2 is the same as that of the prior art system of FIG. 1. However, in the system of FIG. 2, the switch 5 is replaced by a mixer instance 7, and the cache 1 is modified so that it now contains both motion vectors and corresponding matching errors. These matching errors are fed into said mixer instance 7.

The decisive difference between prior art scan-rate conversion systems and the scan-rate conversion system according to the present invention manifests itself at the mixer instance 7 and its inputs. In addition to the interpolated and extrapolated pixels as output by the scan-rate converter 4 and the information on occlusion areas from the occlusion detection instance 6, which may be derived from motion vectors, the mixer instance 7 receives matching error information that indicates the accuracy of the determined motion vectors.

The operation of the mixer instance 7 is schematically depicted in the flowchart of FIG. 3. In a step 10, based on the information from the occlusion detection instance 6, the mixer instance 7 checks if the image area the pixels of which are currently to be scan-rate converted is an occlusion area. If this is not the case, interpolation without causing halo artefacts is possible, and the output pixel is simply set to the interpolated pixel in a step 11. If the image area is identified to be an occlusion area in step 10, the mixer instance 6 checks whether a matching error that is made available to said mixer instance 6 by said cache 1 is below a certain threshold value in a step 12. Note that, due to the fact that the present image area is an occlusion area that causes the corresponding matching error to be grossly inaccurate, the matching error as checked in step 12 is not taken from the present image area, but from a neighboring image area which is identified to be a non-occlusion area and the corresponding motion vector of which is close to a determined background vector. If the decision in step 12 is positive, the matching errors are considered low, and, correspondingly, the determined motion vectors are assumed to be accurate, so that the output pixel can be set to the extrapolated pixel in a step 13 without causing new types of artefacts. Alternatively, if the decision in step 12 is negative, a weighted sum of the interpolated and extrapolated pixel is output by the scan rate conversion system. To this end, first weight factors wₑ and wᵢ are derived in a step 14 from the matching error as used in step 12, and, finally, in a step 15, the output pixel is set to the weighted sum of the interpolated and extrapolated pixel.

The invention has been described above by means of embodiments. It should be noted that there are alternative ways and variations which are obvious to a skilled person in the art and can be implemented without deviating from the scope and spirit of the appended claims. In particular, different techniques for the detection of occlusions and for the inter- and extrapolation may be applied, and within the mixing step, alternative criteria to control the fading between an output pixel that is entirely composed of the extrapolated pixel and an output pixel that is entirely composed of the interpolated pixel may be used. This may for instance comprise a Mean Square Error (MSE) matching error criterion, but also all types of matching error criteria that are calculated on the basis of lines of pixels or certain grids or structures of pixels, in particular to save computations. Instead of performing the inter- and extrapolation for image areas of images only, it might be advantageous to perform them for entire images. It is readily seen that not only the detection of an occlusion area, but also the detection of other image characteristics that lead to performance degradation of bi-directional interpolation may be used in the present invention to indicate that unidirectional extrapolation might be advantageous.

1. A method for scan-rate conversion of an image signal, comprising:
interpolating between at least a first image area of a first image of said image signal and a second image area of a second image of said image signal to obtain at least one interpolated image area;
extrapolating at least one image area of at least one image of said image signal to obtain at least one extrapolated image area: and
mixing said at least one interpolated image area and said at least one extrapolated image area to obtain a mixed image area.

2. The method according to claim 1, further comprising:
identifying occlusion areas in said images of said image signal.

3. The method according to claim 2, wherein said step of mixing is at least partially performed in dependence on a decision whether said image areas that are interpolated and/or extrapolated are occlusion areas.

4. The method according to claim 1, further comprising:
determining at least one motion vector and at least one associated matching error for at least one image area of at least one image of said image signal.

5. The method according to claim 4, wherein said step of mixing is at least partially performed in dependence on said at least one determined matching error.

6. The method according to claim 4, wherein said at least one matching error is determined according to a Sum of Absolute Differences (SAD) criterion.

7. The method according to claim 4, wherein said at least one matching error is determined on the basis of pixels, lines, blocks or fields and in a predefined pattern for said at least one image area.

8. The method according to claim 5, wherein said at least one matching error, in dependence on which said step of mixing is performed, corresponds to an image area that is a non-occlusion area.

9. The method according to claim 8, wherein said non-occlusion image area is selected in dependence on the difference between its corresponding motion vector and a desired motion vector.

10. The method according to claim 9, wherein said non-occlusion area is located in the vicinity of at least one occlusion area that is interpolated and/or extrapolated.

11. A computer program with instructions operable to cause a processor to perform the method steps of claim 1.

12. A computer program product comprising a computer program with instructions operable to cause a processor to perform the method steps of claim 1.

13. A device for scan-rate conversion of an image signal, comprising:
means for interpolating between at least a first image area of a first image of said image signal and a second image area of a second image of said image signal to obtain at least one interpolated image area;
means for extrapolating at least one image area of at least one image of said image signal to obtain at least one extrapolated image area: and
means for mixing said at least one interpolated image area and said at least one extrapolated image area to obtain a mixed image area.

14. The device according to claim 13, further comprising:
means for identifying occlusion areas in said images of said image signal.

15. The device according to claim 13, further comprising:
means for determining at least one motion vector and at least one associated matching error for at least one image area of at least one image of said image signal.
